(19) United States
(12) Patent Application Publication
(10) Pub. No.: US 2012/0058240 A1
(43) Pub. Date: Mar. 8, 2012

(54) STABLE FUNCTIONAL BEVERAGE COMPOSITIONS AND METHODS OF MAKING SAME

(75) Inventors: Richard F. Ablett, Charlottetown (CA); Lei Gao, Charlottetown (CA)

(73) Assignee: HER MAJESTY THE QUEEN IN RIGHT OF THE PROVINCE OF NOVA SCOTIA, AS REPRESENTED BY THE NOVA SCOTIA AGR, Truro (CA)

(21) Appl. No.: 13/320,168

(22) PCT Filed: May 14, 2010
(86) PCT No.: PCT/CA2010/000713

§ 371 Date: Nov. 11, 2011

Related U.S. Application Data
(60) Provisional application No. 61/178,562, filed on May 15, 2009.

(51) Int. Cl. A23C 9/152; A23C 3/02; A23L 2/46; A23L 2/66

(52) U.S. Cl. 426/580; 426/590

(57) ABSTRACT

The invention relates to processes for manufacturing stable functional protein-containing beverage compositions, such as dairy-based beverages. A functional ingredient, such as yeast beta-glucan, is stabilized in the protein-containing composition by subjecting the composition to intense agitation, e.g. homogenization or sonication. Advantageously, these processes permits heat-treatment of the functional beverage composition for extended shelf-life of the final product. Stable functional beverage compositions prepared by these processes are also provided.

### FIELD OF THE INVENTION

The present invention relates generally to food compositions, including beverage compositions. More particularly, the present invention relates to stable functional beverage compositions and processes for making same.

### BACKGROUND OF THE INVENTION

Functional foods are foods or dietary components that provide a health benefit beyond basic nutrition. Examples of functional foods include fortified or enhanced foods, including beverages, and some dietary supplements. Also included are unmodified foods having a health claim associated with them. Functional foods provide an important opportunity to enhance general health, prevent disease, reduce health-care costs, and support economic development, especially in rural communities. There is an increasing demand for functional foods and, correspondingly, for improved means of incorporating functional ingredients into existing foods. Some well-known examples of functional foods include fruits, vegetables and their juices, and dairy products. Some well-known examples of functional ingredients include soluble fibre from oats and barley; omega-3 fatty acids from fish and flax oil; phytoestrogens and antioxidants from plant materials; plant sterols and stanols from vegetable oils; and protein from soy.

There are many challenges faced by those working in the functional foods industry. Some of the main challenges relate to difficulty and cost associated with manufacturing the functional ingredients, incompatibility of functional ingredients with certain foods, including chemical reaction among food molecules during processing, solubility and stability issues, undesirable smell or color changes in the intended food carrier systems, and difficulty and economic feasibility in developing and carrying out processes for making the functional food products.

Beta-glucans are polysaccharides found primarily in the bran of cereal grains and in the cell wall of certain lower level biota, including yeast, certain types of mold, fungi, mushrooms and bacteria. The cereal based beta-glucans occur most abundantly in barley and oats and are useful in human nutrition, predominantly as texturizing agents and soluble fiber supplements. They tend to be soluble and comprise chains of beta-linked D-glucose molecules connected at the 1 and 3 positions to form a 1,3-beta-D-glucan backbone. Smaller side chains are connected to the polysaccharide backbone through 1,4 linkages. Thus, the beta-glucans derived from cereals tend to be soluble 1,3/1,4-beta-D-glucans.

There are important differences between the beta-glucans derived from plants and those derived from low level biota, such as yeast. The beta-glucans derived from yeast and other low level biota differ in structure from their plant-derived counterparts and can also incur/confer biological activity to higher life forms. It is believed that beta-glucans containing 1,6 side chains branching off from the longer 1,3-beta-D-glucan backbone are the most biologically active of the 1,3-beta-D-glucans. Importantly, these biologically active beta-glucans have been shown to confer immunological activity. Much literature describes the immune system and responses of higher species, such as livestock and humans, towards these immune-enhancing beta-glucan molecules. Therefore, these molecules have important implications for the health of animals and humans (Perez-Guisado, 2007; Zekovic, et al., 2005). Thus, one potential use of these molecules is in modulating the immune responses of higher species (Ohno, 2005; Yadomae, 1992; Sandula, 1995; Miura, et al., 2003).

Some researchers have suggested that it is the frequency, location, and length of the side chains that determine the immune-enhancing activity of beta-glucans. Yeast-derived beta-glucans having the 1,3/1,6-beta-D-glucan structure have been shown to be effective activators of non-specific immunity and have been referred to as a “biologic defense modifiers” (BDM). Beta-glucans derived from certain other lower level biota share this general structure. The 1,3/1,6-beta-D-glucans are thought to improve immune system defenses against foreign invaders by enhancing the ability of macrophages, neutrophils and natural killer cells to respond to and fight a wide range of challenges. In contrast, the 1,3/1,4-beta-D-glucans derived from cereals are not known for immune-stimulating benefits.

Many different methods may be used to extract beta-glucan from yeast or other low level biota species. One example is that by Greenshields (1999), which teaches the extraction of yeast beta-glucan using a food grade alkaline salt. Regardless of the method of extraction used, the beta-glucans extracted from yeast and certain other low level biota tend to exhibit beneficial immunological properties, although differences in solubility may necessitate different methods of extraction or preparation.

The 1,3/1,6-beta-D-glucans tend to be insoluble in their native form and thus present certain challenges in the food industry. For example, water-insoluble beta-glucans pose problems of stability or uniformity in beverage suspensions. Additionally, large insoluble carbohydrate molecules, including the insoluble beta-glucans, tend to interact with proteins to form precipitates, thereby impacting on the manufacture of stable protein-containing suspensions. As a dietary supplement, the most common forms of immune-enhancing beta-glucans are therefore capsules and tablets. However, current market trends indicate that preferences are shifting away from ingestion of capsules and tablets toward functional foods, including beverages.

U.S. Pat. No. 5,576,015 (Donzis) teaches the oral or parenteral administration of yeast cell wall beta-glucans in dermalogical and nutritional applications. However, it does not teach the use of beta-glucan in heat-treated or dairy beverages or processes for the manufacture thereof.

U.S. Pat. No. 4,962,094 (Spiros et al.) teaches the use of yeast-derived beta-glucan in the diet as a source of fiber.

U.S. Pat. No. 6,214,337 (Hayden et al.) teaches the use of beta-glucan in solid animal feeds. WO 2008/051862 (Sorgente et al.) also describes solid food or animal feed compositions for enhancing immunocompetence in an animal. The compositions comprise (1-3),(1-6)-beta-glucan and an additive, selected from zinc and Vitamin D, which are reported to act synergistically.

EP 1,908,358 (Neugebauer) describes a health food composition containing beta-glucan and a dairy carrier for improved bioavailability. The formulated product is not subjected to a pasteurization step and must therefore be stored under refrigerated conditions in order to maintain a shelf life up to a few weeks. Heat treatment, such as pasteurization, or sterilization which operates at even higher temperature, are required for longer shelf life of dairy and other products. Unfortunately, heat-treatment processes trigger interactions of molecules and subsequent precipitation of ingredients, which impacts negatively on the sensory qualities of a consumable product. Even without heat treatment, insoluble beta-glucans naturally pose a problem of stability in solutions or suspensions, such as beverages, and tend to interact with proteins to form precipitates, which is worsened upon heating, thereby negatively impacting on the manufacture of stable suspensions. Such challenges therefore limit availability of such functional ingredients to consumers in beverage formats.

Other functional ingredients also pose challenges in the beverage industry. For instance, phenolic compounds, such as anthocyanins and procyanidins, are rich in fruits and fruit products and are responsible for the different blue and purple colours of the fruits, as well as many desirable biological activities such as antioxidant activities (e.g. blueberries) and anti-urinary tract infections (e.g. cranberries). These health-promoting properties make such compounds desirable as functional ingredients. Unfortunately, these compounds also have a tendency to interact with other molecules, particularly proteins, such as those in dairy products, and form coagulates and eventually precipitates. Again, heat treatment, such as pasteurization or sterilization as required for obtaining acceptable shelf life of consumer products, will initiate such reactions and cause the functional ingredients to form precipitates with the protein molecules.

One possible option to overcome this challenge is to add the incompatible functional ingredients following the heat treatment step. However, this practice would require the ingredient to be heat-treated separately and added together aseptically afterwards, which would require separate and specialized equipment to carry out and would cause a significant economic hurdle for the manufacture of the product. Moreover, the ingredients may still precipitate out over time.

It is therefore desirable to provide improved processes for incorporating functional ingredients into foods in order to provide stable food products, including beverages, and to therefore provide new and useful functional food compositions containing health-promoting functional ingredients.

### SUMMARY OF THE INVENTION

It is desirable to provide stable functional food compositions that can withstand heat-treatment. Processes leading to the production of such compositions are desirable.

In a first aspect, the present invention provides a process for preparing a stable functional beverage composition, which comprises obtaining a suitable protein-containing carrier; adding a functional ingredient to the carrier to provide a beverage composition; and subjecting the beverage composition to intense agitation during and/or after addition of the functional ingredient to thereby stabilize the beverage composition.

In one embodiment, the intense agitation is homogenization or sonication.

In some embodiments, the process further comprises a heat-treatment step for extended shelf-life of the stable functional food composition. The heat treatment step may, for example be pasteurization or sterilization.

In a further aspect, the present invention provides a stable functional beverage composition prepared by the processes described herein, which composition comprises a protein-containing carrier; and a functional ingredient.

In another aspect, the invention provides the process and a stable functional beverage composition that is concentrated to contain more dietary servings of food than each food component in the composition would account for in the same volume. Therefore, the volume for a serving of milk may contain the nutritional contents for a serving of milk and a serving of fruit in the same volume, for example.

In some embodiments, the carrier is a dairy product.

In some embodiments, the functional ingredient is an immune-enhancing beta-glucan and/or a fruit extract having antioxidant and/or antimicrobial properties.

In some embodiments, the stable functional beverage composition is shelf-stable.

In another aspect, there is provided, a shelf-stable functional dairy beverage composition comprising yeast-derived beta-glucan.

In another aspect, there is provided, a shelf-stable functional dairy beverage composition comprising a fruit extract, or a combination of fruit extracts.

Other aspects and features of the present invention will become apparent to those ordinarily skilled in the art upon review of the following description of specific embodiments of the invention in conjunction with the accompanying figure.

### BRIEF DESCRIPTION OF THE DRAWINGS

Embodiments of the present invention will now be described, by way of example only, with reference to the attached figure.

FIG. 1 illustrates the effect of sonication treatment on the stability of a suspension of yeast cell wall beta-glucan in skim milk, where a vortex was used in place of sonication as the control.

### DETAILED DESCRIPTION

Generally, the present invention provides functional food compositions and processes for producing same. In particular, the present invention provides stable functional food products, such as beverages, that contain health-promoting functional ingredients.

There is an increasing demand for functional ingredients and foods comprising them. However, manufacturers working in the functional foods industry face significant challenges. Functional ingredients are often difficult and expensive to manufacture, and they are sometimes incompatible with the food products to which they are to be added, therefore limiting their use. Incompatibility of functional ingredients can result from solubility issues, stability issues, or interactions between components of the functional ingredient and the food product, which can lead to precipitation or agglomeration of ingredients and therefore negatively impact the final product. This is especially a problem in the functional beverage industry where the manufacture of stable solutions and suspensions comprising incompatible functional ingredients can be particularly challenging. For effective distribution and consumer interest, the final functional food composition comprising the functional ingredient should be stable and should have desirable sensory and nutritional qualities.

In accordance with the present invention, the functional food composition is typically, but not always, a functional beverage composition.

Described herein are processes for manufacturing functional food compositions, such as beverage compositions, which are stable functional food compositions, and which may advantageously comprise otherwise substantially incompatible functional ingredients. By substantially incompatible, it is meant the functional ingredient is naturally somewhat prone to solubility issues, interactions, or stability issues when combined with the selected food product.

Specifically, there is provided a process for preparing a stable functional beverage composition comprising: obtaining a suitable protein-containing carrier; adding a functional ingredient to the carrier to provide a beverage composition; and subjecting the beverage composition to intense agitation during and/or after addition of the functional ingredient to thereby stabilize the beverage composition to form a stable functional beverage composition. The intense agitation may be homogenization or sonication. Optionally, heat-treatment may be used to extend the shelf-life of the beverage composition. The heat-treatment may carried out after the intense agitation. The heat-treatment may comprise sterilization, to render the stable functional beverage composition shelf-stable. Heat-treatment may comprises UHT. Optionally, the pH of the beverage composition may be adjusted to be optimal for shelf stability. In one embodiment of the process, the protein-containing carrier is milk and the functional ingredient comprises beta-glucan derived from a yeast cell wall.

Described herein are shelf-stable functional dairy beverage compositions comprising yeast-derived beta-glucan. Further, shelf-stable functional dairy beverage compositions comprising a fruit extract are described herein. Such compositions may be prepared as a result of the process described herein, or can be prepared by other processes.

Within the beverage composition, the protein-containing carrier may be a dairy product and the functional ingredient may comprise an immune-enhancing beta-glucan; and/or a fruit extract having antioxidant and/or antimicrobial properties. The beta-glucan may be one derived from yeast cell wall, such as for example, derived from Saccharomyces cerevisiae. An exemplary range the beta-glucan concentration may be from about 10 mg/L to about 20,000 mg/L, and certain embodiments of the invention may include from 10 to 100 mg of β-glucan per 250 mL serving. The beverage may contain a fruit extract such blueberry extract, cranberry extract, Saskatoon extract, pomegranate concentrate, or a combination thereof as an exemplary functional ingredient.

The beverage composition may be one which is heat-treated for extended shelf-life. The composition may be rendered shelf-stable, for example for a period of at least 12 months.

When the protein-containing carrier comprises a dairy product, milk or a milk derivative can be used. The milk or milk derivative may be lactose-free.

A stable functional beverage composition described herein which is prepared by the process described herein may contain the protein-containing carrier in a concentrated form, and/or the functional ingredient in a concentrated form.

The volume deemed to be a typical serving size for the beverage composition may comprise within it one serving of the protein-containing carrier (for example “milk”) and may simultaneously include one serving of the functional ingredient (for example “fruit or vegetable”) within the same volume. Advantageously in this way, a consumer will be able to consume the beverage composition and meet two daily serving requirements simultaneously, without having to consume separate items to meet one serving from the “milk” group and one serving from the “fruit or vegetable” group.

In instances where the beverage composition comprises the protein-containing carrier as milk, skim milk, buttermilk, yogurt or another form of dairy product, this can be recognized as a serving in the dairy (or milk/milk products/milk alternatives) category in a food guide recommended by a health authority, such as by Health Canada, the USFDA, or another government health authority, such as WHO.

The functional ingredient in the beverage composition comprises a juice concentrate, puree or other extract of a fruit or vegetable that is recognized in the fruit or vegetable category in a food guide recommended by Health Canada, the USFDA, or another government health authority. Advantageously, the conscientious consumer would be able to attribute a serving of fruit or vegetable toward his or her daily requirement.

Furthermore, certain embodiments of the processes described herein permit successful heat-treatment, such as pasteurization or sterilization, of the functional food compositions. The ability to pasteurize or even sterilize the functional food composition has a significant positive impact on the shelf-life of the product.

The shelf life of a product refers to the amount of time before a food, beverage, medicine, or other perishable item is considered unsuitable for sale or consumption. Shelf life is influenced by many factors, such as packaging, exposure to light, transmission of gasses, and importantly, contamination by microbes. Refrigeration is often used to extend the shelf life of food products that are prone to spoilage by microbes, such as dairy products. Separation or precipitation would also cause expiration of shelf-life, such as, milk separation due to milk protein coagulation caused by addition of juice microbial growth or addition of fruit juices.

Pasteurization refers to heat-treatment processes that destroys certain microorganisms, particularly pathogenic and spoilage microbes, in food products and can therefore extend the shelf life of products that are prone to spoilage, such as dairy products. Protein-containing products, such as dairy beverages, are susceptible to changes in appearance, texture and taste, among other factors, in response to heat-treatment. Pasteurization typically uses temperatures that are below boiling point to avoid irreversible agglomeration (e.g. curdling) in the product. There are two main types of pasteurization used today: High temperature/Short Time (HTST) and Extended Shelf Life (ESL) treatment. In the HTST process, milk is forced between metal plates or through pipes heated on the outside by hot water, and is heated to about 70° C. for about 15-20 seconds. ESL milk has stronger or additional treatment than regular pasteurization, such as a microbial filtration step or longer/higher temperature treatment to achieve extended shelf life. Ultra-high temperature (UHT or ultra-heat-treated) is also used to treat dairy products. UHT processing holds the milk at a higher temperature, up to about 150° C., for a short time. Milk simply labeled “pasteurized” is usually treated with the HTST method, whereas milk labeled “ultra-pasteurized” or “UHT” has been treated with the UHT method. A newer method called flash pasteurization involves shorter exposure to higher temperatures, and is claimed to be better for preserving color and taste in some products. Skilled manufacturers may modify or optimize pasteurization techniques to meet their needs.

A stable product is one that will not undergo significant physico-chemical, microbiological or sensory changes (e.g. taste, smell, colour, texture, separation) for an extended period of time. An unstable product will have a very short shelf life, whereas a stable product will have a longer shelf life. Some products require some changes following the manufacturing process, such as, aging in cheese, to develop the desired flavour, provided there are no spoilage issues.

A shelf-stable product is one that remains stable (on the shelf) at room temperature for an extended period of time. The key difference here is that shelf-stable products are stable because they are essentially sterile (free of microorganisms for food spoilage), which is called commercially sterile, whereas the non-shelf stable products are not sterile and would be spoiled by microbial growth, which happens rapidly at room temperature. In the industry, the sterile condition in the product is usually achieved by heat-treatment that kills the microorganisms in the product. Once the products are sterile, they are usually stable for an extended period, typically from six months to a year depending on the type of product. UHT treatment may be considered a form of commercial sterilization.

Unfortunately, the heat required to kill microorganisms (e.g. sterilization), or even to slow their growth (e.g. pasteurization), can also destroy the integrity or quality of the food product by causing agglomeration, separation or in many cases, color, texture and taste changes in the product, particularly in protein-containing products. Furthermore, heat-treatment can trigger interactions between proteins and other ingredients in the food composition, including functional ingredients, leading to precipitation, agglomeration and other negative effects.

In accordance with the present invention, processes have been developed that provide functional food compositions, having improved stability, and furthermore extended shelf life. Shelf life is extended because the process permits heat-treatment of food composition while maintaining the quality of the products. In many embodiments, the functional food composition is a protein-containing beverage comprising a functional ingredient whose stability in the beverage is improved by the process of manufacture.

In some embodiments, shelf stable products are prepared. The shelf stable products may have a shelf life of, for example, at least 6 months, at least 8 months, at least 10 months, or at least 12 months. Preferably, the shelf stable products have a shelf life of at least 12 months. In order to develop shelf-stable functional food compositions in accordance with the invention, it was necessary to develop new processes for manufacturing the enhanced shelf stable products. The new processes for manufacture advantageously permit the functional ingredients to remain stable in the composition for extended periods of time and permit a heat-treatment step (e.g. pasteurization or sterilization) to be successfully carried out such that shelf-stable food compositions comprising functional ingredients can be provided.

The inclusion of functional ingredients in heat-treated beverage compositions satisfies a need in the art for said stable functional beverage compositions suitable for consumption by humans and animals. In producing a stable functional food product for human or animal consumption, it is important that there is no significant compromise of sensory properties or nutritional quality. In particular, there has been a need for processes for successfully incorporating functional ingredients into protein-containing beverages, such as dairy products and non-dairy protein-containing beverages that require heat-treatment in order to extend shelf life or be rendered shelf-stable. Certain functional ingredients, such as certain immune-enhancing agents and antioxidant/antimicrobial agents, are particularly difficult to stabilize in a protein-containing beverage, especially one that must be subject to heat-treatment. Insolubility is one negative factor that must be overcome. Also, interaction, separation, agglomeration and/or precipitation of ingredients are common problems that occur in response to heat treatment. These problems negatively impact the sensory properties and often the nutritional quality of the compositions.

The successful inclusion of insoluble or substantially incompatible functional ingredients in a dairy beverage format, such as immune-enhancing beta-glucan as an immune-enhancing agent and/or fruit derived extracts as an antioxidant/antimicrobial agent, supports creation of new formats of food formulation that have new uses as healthy products.

In addition, the inclusion of these functional ingredients in a dairy based beverage without the change of serving size or volume of the dairy or the functional foods is a novel idea for the creation of new food formulations that will accomplish dietary needs for health conscious consumers.

It was surprisingly found that the process described herein could enhance the stability of normally unstable food formulations that contain otherwise incompatible ingredients. It was further found that the described process could stabilize the otherwise unstable formulations even at higher concentrations than those that food ingredients naturally have. In addition, the process would enhance the stability of these formulations even at UHT treatment temperatures. The processes are considered advantageous to those experienced in the art of dairy beverage product formulations. The created products complement other food ingredients and products, and possess long shelf life as a result of heat treatment, which supports economical distribution of the products.

In addition to new formulations created herein, the process for incorporation solves the problem of incompatibility of certain functional ingredients, such as yeast-derived beta-glucan or fruit extracts, with protein-containing foods such as dairy beverages, by a novel combination of food processing unit operations. Thereby, the new processes successfully create new food compositions containing beta-glucan or fruit extracts. Particularly, these food compositions are made to contain the functional food components in a desired proportion that a specified volume/quantity of the composition can accommodate a desired dietary quantity of the components, either a functional food from a dietary food group or a specific food component.

In one embodiment, the combination of process unit operation includes homogenization/sonication followed by pasteurization/sterilization under the described parameters of operation. This forms an advantageous process for this type of food composition, and the resulting food compositions are advantageous over previous compositions that have not been able to successfully include such ingredients in a stable form. The created functional food compositions function as a health food for health conscious consumers and/or their animals.

The stable functional food compositions of the invention comprise a carrier, and a functional ingredient.

“Food composition” or “food product” refers to a liquid, semi-solid or solid food products or nutritional composition, suitable for human or animal consumption, including free-flowing and semi-solid beverage compositions. In preferred embodiment, the food composition is a beverage composition.

As used herein, the term “comprising” is to be interpreted as specifying the presence of the stated parts, steps or components, but does not exclude the presence of one or more additional parts, steps or components.

In addition, reference to an element by the indefinite article “a” or “an” does not exclude the possibility that more than one of the elements is present, unless the context clearly requires that there be one and only one of the elements. The indefinite article “a” or “an” thus usually means “at least one”.

In accordance with embodiments of the invention, the functional food composition comprises a desired carrier for the one or more functional ingredients. The carrier will generally form the base ingredient for the composition. The carrier itself may be a single ingredient or a mixture of ingredients, such as a formulation. In some embodiments, the carrier is a protein-containing liquid or semi-liquid.

The term milk is intended to encompass various types of milky substances such as dairy milk, soy milk, almond milk, coconut milk, fermented milk, yogurt, kefir whey, dairy drink and the like.

In some embodiments, the carrier is a dairy product. Dairy products include, comprise, or are derived from, dairy milk. Dairy milk may come from one of various mammals, including cow, sheep, goat, buffalo, camel, donkey, horse, reindeer, water buffalo, or yak, among others. Other mammals may also produce diary milk. The most common sources of dairy milk for commercial human or animal consumption are cow, sheep, and goat.

The dairy product can be, for example, dairy milk itself or a derivative thereof, such as a dairy-based beverage or a dairy food product. Dairy milk or a derivative thereof may include fresh milk, pasteurized milk, whole milk, part-skim milk, skim milk, lactose-free milk, fortified milk, fermented milk, yogurt, or cream, among others. A dairy-based beverage may include a milk formulation, a yoghurt beverage, a milkshake, or flavored milk, among others. A dairy food product may include semi-solid foods, for example, yoghurt, pudding, or ice cream.

In one embodiment, the dairy product is milk or a derivative thereof.

In one embodiment, the dairy product is lactose-reduced or lactose-free milk.

In one embodiment, the carrier is a dairy-based milkshake, such as a chocolate, vanilla or strawberry milkshake.

In another embodiment, the carrier is a lactose free dairy-based milkshake, such as a chocolate, vanilla or strawberry milkshake.

The carrier may also be a non-dairy protein-containing carrier. In one embodiment, the carrier is a water-based high protein beverage, such as a whey-protein beverage.

The functional food composition may comprise one or more non-nutritional additives, such as flavors, coloring agents, spices, sweeteners, emulsifiers, thickeners, excipients or preservatives, among others.

Sweeteners may include, for example, natural or artificial sweeteners, e.g., saccharides, cyclamates, aspartamine, aspartame, acesulfame K, and/or sorbitol.

Preservatives may include, for example, potassium sorbate, sodium sorbate, potassium benzoate, sodium benzoate or calcium disodium EDTA.

Importantly, the functional food composition comprises one or more functional ingredients for the promotion of health. Functional ingredients may include, for example, an immune-enhancing agent, an antioxidant, an antimicrobial, a vitamin supplement, a mineral supplement, a fatty acid supplement (e.g. an omega-3 fatty acid), an energy supplement, a fruit or vegetable concentrate, a fruit or vegetable extract, a fruit product, or a fiber supplement. In some embodiments, the functional ingredient is an extract prepared from a plant or low level biota. In some embodiments, the functional ingredient is one that is typically considered incompatible for use in a stable or shelf-stable beverage composition, particularly, a heat-treated protein-containing composition. Many such functional ingredients are known in the art, whose uses are currently limited in the beverage industry for this reason.

In some embodiments, the functional food composition comprises an immune-enhancing beta-glucan as an immune-enhancing agent, and/or a fruit extract as an antioxidant and/or antimicrobial agent.

In some embodiments, the health-promoting fruit extract is blueberry extract, cranberry extract, Saskatoon extract, or pomegranate concentrate.

As used herein, immune-enhancing beta-glucan refers to a beta-glucan derived from a non-plant source, such as yeast or a low level biota, and having immune-enhancing properties. In one embodiment, the beta-glucan is derived from yeast cell wall. In one embodiment, the beta-glucan is from a highly refined yeast cell wall extract.

Immune-enhancing beta-glucan may be derived from various yeast strains. Exemplary strains include, but are not limited to, Saccharomyces cerevisiae, Saccharomyces delbrueckii, Saccharomyces rosei, Saccharomyces microellipsodes, Saccharomyces carlsbergensis, Saccharomyces bisporus, Saccharomyces fermentati, Saccharomyces rouxii, Schizosaccharomyces pombe, Kluyveromyces polysporus, Candida albicans, Candida cloacae, Candida tropicalis, Candida utilis, Hansenula wingei, Hansenula arni, Hansenula henricii, Hansenula americana, Hansenula canadiensis, Hansenula capsulata, Hansenula polymorpha, Pichia kluyveri, Pichia pastoris, Pichia polymorpha, Pichia rhodanensis, Pichia ohmeri, Torulopsis bovina, and Torulopsis glabrata.

For example, a yeast beta-1,3/1,6-D-glucan suitable for use in practice of the invention can be obtained from the yeast Saccharaomyces cerevisiae. Such beta-glucan may be derived from yeast cells or from a yeast cell wall preparation. A soluble form of beta-1,3/1,6-D-glucan can be prepared from purified yeast beta-1,3/1,6- D-glucan by enzymatic degradation with a beta endoglucanase. Other beta-glucans that may be suitable for use in practice of the invention include, a beta-glucan isolated from mushroom, e.g. Agaricus blazei, shitake mushrooms, Sclerotium glucanicum, etc., as well as commercial preparations such as AGRASTEVI® and PURESTIM®.

Modified yeast-derived beta-glucans having improved stability and viscosity characteristics are also suitable for use in accordance with the present invention, as well as beta-glucans derived from mutant yeast strains, such as those described in U.S. Pat. No. 5,250,436. An exemplary mutant yeast strain described therein is mutant yeast strain R4, derived from a yeast strain of Saccharomyces cerevisiae, available from the United States Department of Agriculture, Agricultural Research Service, Midwest Area National Center for Agricultural Utilization Research, 1815 North University Street, Peoria, Ill. 61604 (309-685-4011) under No. NRRL Y-15903.

U.S. Pat. No. 6,476,003 discloses a unique process for the production of non-aggregated microparticulate beta-1,3/1,6-glucan that may also suitable for use in accordance with the present invention. The product is manufactured as MG (microparticulate glucan) Beta-glucan products by NSC Immunition.

There are a number of companies that market yeast-derived and other immune-enhancing beta-glucans. Their structure, purity and biological activity can vary depending on, for example, the source of beta-glucan, structure of beta-glucan, purification and extraction techniques used, degree of refinement, and modifications made to the beta-glucan or the organism producing the beta-glucan. A skilled person a can readily select a suitable beta-glucan for use in accordance with the present invention and adjust the ranges.

The food composition may comprise a “therapeutically effective amount” of a functional ingredient sufficient to contribute to the general health of a human or animal consuming the composition. For example, the composition may comprise a therapeutically effective amount of beta-glucan sufficient to, for example, enhance immunocompetence. Those of skill in the art will consider such factors as quality and purity of the beta-glucan, source of beta-glucan, species of animal, age, level of activity, hormone balance, and general health in determining the therapeutically effective amount, which may be administered as a standard healthy dose or, optionally, tailored to the individual subject.

The food composition in the final marketable package for consumers may take the form or shape or size of a dietary food portion (e.g. a serving) as defined by Health Authorities such as Health Canada (Ottawa) or USDA (Washington, D.C). Furthermore, the food composition in the final marketable package, although in the form, shape or size of one dietary portion (serving) may contain two or more servings of dietary servings from one or more food groups recommended by the health authorities.

The reported therapeutic range for beta-glucan consumption for humans typically ranges from about 40 mg to 3000 mg daily. The dosage range can vary depending upon body weight and whether it is being used for maintenance or an acute condition. As a dietary supplement (maintenance use), the most common human dose range has been reported as about 40 to about 500 mg per day. When the dosage is reported on a kilogram of body weight basis the dose range is generally about 2-6 mg/kg. If a particulate beta-glucan is being self-administered for an acute condition, a higher dose of about 500-3000 mg/day may be administered.

The amount of beta-glucan, or other functional ingredients, in the composition, should preferably be selected such that the ingredient does not negatively impact the sensory or physico-chemical properties of the carrier or the final product. A dosage that is both effective and economical may optimally be selected. At these levels of inclusion, it is envisaged the beta-glucan fraction derived from refined yeast cell wall material would not particularly interfere with sensory or physico-chemical properties of the dairy carrier formulation.

The process for inclusion is specific to the product so that the beta-glucan will survive necessary processing conditions for stability and remain stable and effective in the final product.

The functional food compositions of the invention may be prepared for human or animal consumption. For example, the food composition may be provided to livestock or companion animals. Companion animals may include, but are not limited to, cats, dogs, horses, and other mammals.

In one embodiment, the food composition is a shelf-stable lactose-free milk beverage comprising immune-enhancing beta-glucan. The composition is particularly well suited for cats, who are lactose intolerant past weaning.

The functional food compositions of the invention may be provided to consumers in grocery stores, supermarkets, health food stores, pet food stores, and the like. Alternatively, in some embodiments, the functional food compositions are provided in a veterinary or hospital setting to promote health.

In some embodiments of the invention, the functional food composition is a beverage composition comprising immune-enhancing beta-glucan in an amount of about 1 mg/L, 5 mg/L, 10 mg/L, 15 mg/L, 20 mg/L, 25 mg/L, 50 mg/L, 75 mg/L, 100 mg/L, 150 mg/L, 200 mg/L, 250 mg/L, 300 mg/L, 400 mg/L, 500 mg/L, 750 mg/L ,1000 mg/L, 1500 mg/L, 2000 mg/L, 2500 mg/L or 3000 mg/L, 5000 mg/L, 10000 mg/L, 15000 mg/L or 20000 mg/L. The upper end and the lower end of the range can be chosen based on, for example, the daily recommended dosage for the particular beta-glucan selected and the carrying capacity of the beverage composition.

In some embodiments, the beta-glucan is in a range of up to about 20000 mg/L, or up to about 10000 mg/L, or up to about 5000 mg/L, or up to about 1000 mg/L, or up to about 500 mg/L, or up to about 100 mg/L.

In some embodiment, the beta-glucan is present in a range of about 1 to 20000 mg/L, or about 1 mg/L to 10000 mg/L, or about 10 to 5000 to mg/L, or about 100 to 1000 mg/L. In some embodiments, beta-glucan is provided in the composition in an amount of about 40, 120, 200, 500 or 600 mg beta-glucan per 1 L.

The functional food composition may optionally comprise a cultured dairy product carrier, meaning that the dairy product contains health-promoting active bacterial or yeast cultures, such as probiotics, or the health promoting molecules produced by the microbial activity such as fermentation by probiotics. Probiotics are dietary supplements of live bacterial or yeast strains thought to be healthy for the host organism. Common examples include bacterial strains of the genera Lactobaccilus and Bifidobacterium. Probiotics can be added to the functional food composition before or after pasteurization or sterilization.

In one embodiment of the invention, an immune-enhancing beta-glucan is incorporated into a cultured dairy beverage to synergize and complement with the gastrointestinal health benefits of the cultured drink.

The inventive concepts can be applied to other protein-containing beverage compositions besides the exemplified compositions. In addition, a skilled worker will appreciate that additional embodiments can include non-protein containing beverage compositions.

The processes described herein permit the formulation of stable, and shelf-stable, food compositions comprising functional ingredients. The processes are particularly useful in preparing stable, and shelf-stable, protein-containing beverage compositions. Heat-treatment may be required to destroy spoilage causing microbes. Heat-treatment of protein-containing beverages, such as dairy beverages, must be controlled in order to avoid agglomeration of the products or the production of undesirable properties such as caramelization, maillard reactions, or unwanted smell. This challenge is increased significantly when functional ingredients are added to the beverage, particularly functional ingredients that tend to interact with the proteins in the beverage, particularly when subjected to heat-treatment, leading to precipitation, gelling, separation, and other negative outcomes. As such, incorporation of insoluble or reactive functional ingredients into protein-containing beverages requiring extended stability and shelf-life is often unsuccessful or, naturally, avoided. Or, in some cases, the amount of functional ingredient that can be successfully added is too low to have a health-promoting effect. With the increasing demand for functional food compositions, including extended shelf-life and shelf-stable products, there is a need in the art to develop new commercial processes for preparing, stabilizing and sterilizing functional food compositions.

In accordance with the present invention, it was surprisingly discovered that subjecting the composition to intense agitation, such as by homogenization or sonication, e.g. during or after addition of the functional ingredient, had a major beneficial effect in stabilizing the functional ingredient in the carrier. In contrast, subjecting the composition to mild agitation, such as mixing with a vortex, did not achieve this effect. It was also possible to stably suspend larger quantities of functional ingredient in the composition with intense agitation as compared to a composition that was not subjected to intense agitation.

There was a drastic improvement in the stability of the suspension, even without the addition of any other stabilizing aids such as gum or emulsifiers. The results thus show great promise in the use of homogenization/sonication for the stabilization of various functional ingredients in protein-containing suspensions, e.g. beta-glucan or fruit extract in dairy products.

Advantageously, the maximum stabilizing effect was achieved in a very short time, making it economically feasible for a large scale commercial step.

A skilled person can carry out the step of homogenizing or sonicating. Homogenization may be performed, for example, with a commercially-available homogenizer. A Polytron device may also be used. Sonication may be performed, for example, with a commercially-available ultrasonic processor.

Also surprisingly, the intense agitation prepared the composition comprising the functional ingredient to withstand heat-treatment. Experiments were carried out to simulate pasteurization, particularly UHT treatment, as required in the preparation of extended shelf-life and shelf-stable products.

In one embodiment, a functional ingredient was added to the selected carrier and the composition is subjected to intense agitation (e.g. by homogenization or sonication) during and/or after addition.

The composition may be mixed prior to intense agitation to bring the ingredients into a loose suspension.

The composition comprising the functional ingredient is also subjected to a heat-treatment step. In some embodiments, the composition is subjected to heat-treatment after the functional ingredient has been added and stabilized by intense agitation. In other embodiments, the composition is subjected to heat-treatment while the functional ingredient is being added. Or, expressed another way, the functional ingredient is added to the carrier as it is being heated.

In accordance with the present invention, new stable compositions have been formulated that contain functional ingredients, e.g. yeast and fruit extracts that are health promoting ingredients and functional in terms of immune system modulating, antioxidants and antimicrobial. As a result of the discovery of the effect of the sonication and homogenization on stability, it is possible to manufacture a concentrated functional beverage composition that is stable and able to withstand ultra-high temperature sterilization and therefore obtain shelf-stable shelf-life with the UHT treatment. The instant process for manufacture of health enhanced beverage compositions possesses advantages to manufacturers. The manufacturing steps are arranged in such a way that the functional ingredients are stably dispersed and in such a way that the formulation is rendered tolerant to heat treatment such as pasteurization or sterilization. A critical step in the process is the use of intense agitation e.g. homogenization or ultrasonic sonication, of the composition containing the functional ingredient prior to or during the heat treatment. In accordance with the new processes, functional food compositions can be economically manufactured that are shelf stable for a prolonged period of time without compromise of sensory, functional or nutritional quality.

Embodiments of the invention are described in the examples that follow. It will be understood that the scope of the invention is not limited to the formulations and procedures outlined below, which are exemplary.

### EXAMPLES

The initial phase of the research tested three exemplary functional beverage compositions with added beta-glucan and fruit extracts in preliminary trials at laboratory level. To establish proof of concept, the trials were carried out in the laboratory under pasteurization conditions. It is understood that the products produced would require refrigeration for a shelf life of several weeks, and may not represent the final products that will be commercially produced. In further testing of beverage compositions that contain these functional ingredients, pilot tests were carried out and high temperature conditions were applied to simulate actual commercial processing conditions. In both lab and pilot tests, different process steps were tested. It was a surprise to find that ultrasound sonication achieved the desired effect of stabilization of the beverage compositions. It was also discovered that homogenization would also stabilize the ingredients mixture and prepare the formulation to better tolerate heat treatment processing. It was a further surprise to find that the process described herein enhances the stability of food formulations at concentrated levels that are normally unstable even at naturally occurring concentrations. In combination with other processing steps, a sequence of process unit operations were determined for manufacture of stable and functional beverage compositions that contain fruit extracts and/or beta-glucan from yeast.

### Materials

The experiments included testing of several exemplary carriers for health-enhancing functional ingredients. These carriers included existing beverage compositions, skim and other milk. The health enhancing, functional ingredients selected for testing were blueberry extract, cranberry extract, Saskatoon extract, pomegranate concentrate, peach juice concentrate, blueberry juice concentrate, strawberry juice concentrate, banana puree from the respective fruits, and β-glucan extract from yeast cells. The scale of the testing included testing at the laboratory level and the sequence of process testing at the pilot level to determine the technical and economical feasibility of the process.

### Example 1

### Addition of Yeast β-glucan to Dairy Beverages

Three established protein-containing beverages were selected to test the capacity for addition of beta-glucan: (1) Dairy-based vanilla shake; (2) Lactose-free, dairy-based chocolate shake; and (3) Water-based high protein beverage.

The formulae for these beverages are proprietary to the manufacturer.

Pasteurized milk, skim and homogenized were also used.

The beta-glucan used was supplied by International Biologics, Incorporated (Florence, Ky.). The product was derived from either of Baker's or brewer's yeast, Saccharomyces cerevisiae.

The blueberry (Vaccinium angustifolium or lowbush blueberry) fruit extract and cranberry (Vaccinium macrocarpon or American cranberry) fruit extract were produced in a processing facility at the Nova Scotia Agricultural College, Bible Hill, NS. The blueberry extract was a subsample of a batch produced on Oct. 22, 2008; and the cranberry extract was from a batch produced on Mar. 3, 2009, both berries were sourced from Atlantic provinces of Canada. Pomegranate concentrate was from Dynamic Health, NY, N.Y. The pomegranate was produced in California, US.

### High Temperature Sterilization of Yogurt Containing Beverages—Materials and Methods

### Yogourt

Liberté, 0% fat yogourt and 2% fat yogourt, Les Produits De Marque Liberté Inc., 1423 Boul Provencher, Brossard, QC, J4W 1Z3
Astro Original plain yogourt, 1% MF, Parmalat
PC plain yogurt, 1% MF

### Sugar, Lantic Sugar, Lantic Inc., Montreal, QC, H1W2K3

### Pectin, Danisco, USA

Milk powder, Farmers Dairy, Bedford, NS
Buttermilk powder, Farmers Dairy, Bedford, NS

### Milk, 2% MF, Farmers Dairy, Bedford, NS

Lactic Acid, 88%, FCC, from Purac America
Various Fruit juice concentrate, Northwest Naturals, Bothell, Wash.
Yogurt flavour, Givaudan Flavours Corp., Cincinnati, Ohio
Fruit flavour, Ottens Flavours, Henry H. Ottens MFG Co. Inc., Philadelphia, Pa.
Potassium hydroxide, Mallinckrodt, NF Food Grade

### Procedures for Pasteurized Beverage Compositions

Three inclusion levels of β-glucan were tested in each of the three proprietary formulated beverages: 10 mg/250 mL, 30 mg/250 mL and 50 mg/250 ml.

For the two shake formulae, the product was divided into three lots and the amounts of β-glucan were added for the batch size as the beverages were being heated for pasteurization. The beverages were then heated to 85° C./185° F. and held for 40 minutes to simulate ultra-high temperature (UHT) processing. This time-temperature formula was provided by the manufacturer. They were mixed using a Polytron when a homogenizer was not available. The samples were bottled, labeled and stored at 4° C. for evaluation.

For the high protein beverage, the received ingredients were mixed as per manufacturers instructions. The beverage was divided into three lots and the required amount of β-glucan was added to each as it was being heated for pasteurization. Again, each was mixed using a Polytron (with minimal air incorporation) as the homogenizer, bottled, labeled and stored at 4° C.

Viscosity and pH of the samples were determined using a pH meter. Total solids of the beverages will be included in the next round of testing.

These pasteurized beverage compositions were replicated to confirm the results and allowed for comparison of the properties of beverages before and after pasteurization. As with the other two beverages, aliquots of the high protein beverage were taken before and after heat-processing for total solids (duplicate), pH and viscosity.

Other tests and production runs are described in examples to illustrate the different forms and combinations of the use of the process for incorporating and stabilization in the manufacture of the different food compositions.

### Results and Discussion for Pasteurized Beverages

Surprisingly, all three beverages seemed to readily accept the three levels of β-glucan when the addition was carried out with intense agitation, in particular homogenization. It was hydrated and stayed in solution under the conditions used and the mixtures were used for the physical and chemical measurements.

The results suggested that the commercial process conditions (UHT) should be used to simulate the thermal process and to confirm the products are amenable to the more harsh processing conditions.

There was no significant change in pH with the addition of β-glucan to the three beverages.

TABLE 1
pH of Pasteurized Beverage Compositions (Trial 1)

| Sample | pH at 21° C. |
|---|---|
| Vanilla Shake | 6.66 |
| Vanilla Shake - 10 mg/250 ml | 6.67 |
| Vanilla Shake - 30 mg/250 ml | 6.66 |
| Vanilla Shake - 50 mg/250 ml | 6.67 |
| Chocolate Lactose-Free Shake | 6.52 |
| Chocolate L-F Shake - 10 mg/250 ml | 6.52 |
| Chocolate L-F Shake - 30 mg/250 ml | 6.53 |
| Chocolate L-F Shake - 50 mg/250 ml | 6.55 |
| High Protein | 6.87 |
| High Protein - 10 mg/250 ml | 6.86 |
| High Protein - 30 mg/250 ml | 6.92 |
| High Protein - 50 mg/250 ml | 6.92 |

The addition of β-glucan—up to a tested level of 50 mg per 250 ml—to three types of beverages did not result in any negative change to viscosity, pH or processing of the drinks. Under the experimental conditions, β-glucan was observed to mix into homogeneity readily and did not form precipitate. Although it is not an indication of product stability for those that received UHT, it provided the condition for the measurements of the physical and chemical properties of the formulated beverages.

The addition of 50 mg/250 ml of β-glucan did result in a subjectively-perceptible increase in viscosity of the three beverages. This was confirmed by viscometer readings. It is believed to be not significant enough to impact negatively on the processing/packaging of the drinks.

There was no significant change in pH with the addition of β-glucan to the three beverages. Also there was a minimal difference in pH of the samples between Trial 1 and Trial 2. Although the 2-degree higher ambient temperature in Trial 2 would result in a slight drop in pH, the longer heat treatment of the samples with the concomitant moisture loss/viscosity increase would result in a slight increase in pH.

TABLE 2
Solids Concentration of Pasteurized Beverages (Trial 2)

| | % Total | % Total |
|---|---|---|
| | Solids* | Solids* |
| | before | after |
| Sample | pasteurization | pasteurization |
| Vanilla Shake - Control | 26.86 | 27.18 |
| Vanilla Shake - 10 mg β-glucan/250 mL | 26.80 | 27.21 |
| Vanilla Shake - 30 mg β-glucan/250 mL | 26.92 | 27.28 |
| Vanilla Shake - 50 mg β-glucan/250 mL | 27.13 | 27.42 |
| Chocolate Lactose-Free Shake - Control | 17.12 | 17.57 |
| Chocolate L-F Shake - 10 mg β- | 16.95 | 17.34 |
| glucan/250 mL | | |
| Chocolate L-F Shake - 30 mg β- | 17.18 | 17.67 |
| glucan/250 mL | | |
| Chocolate L-F Shake - 50 mg β- | 17.30 | 17.79 |
| glucan/250 mL | | |
| High Protein - Control | 17.01 | 17.35 |
| High Protein - 10 mg β-glucan/250 mL | 17.11 | 17.54 |
| High Protein - 30 mg β-glucan/250 mL | 17.17 | 17.53 |
| High Protein - 50 mg β-glucan/250 mL | 17.11 | 17.49 |

*Total Solids - determined by drying samples in duplicate, on sand, at 41° C./105° F. to a constant weight.

TABLE 3
pH of Beverage Compositions Before and After Pasteurization

| | pH* at 23° C. - | pH* at 23° C. - |
|---|---|---|
| | before | after |
| Sample | pasteurization | pasteurization |
| Vanilla Shake - Control | 6.62 | 6.69 |
| Vanilla Shake - 10 mg β-glucan/250 mL | 6.62 | 6.68 |
| Vanilla Shake - 30 mg β-glucan/250 mL | 6.64 | 6.69 |
| Vanilla Shake - 50 mg β-glucan/250 mL | 6.69 | 6.76 |
| Chocolate Lactose-Free Shake - Control | 6.47 | 6.51 |
| Chocolate L-F Shake - 10 mg | 6.49 | 6.52 |
| β-glucan/250 mL | | |
| Chocolate L-F Shake - 30 mg | 6.50 | 6.55 |
| β-glucan/250 mL | | |
| Chocolate L-F Shake - 50 mg | 6.52 | 6.59 |
| β-glucan/250 mL | | |
| High Protein - Control | 6.79 | 6.82 |
| High Protein - 10 mg β-glucan/250 mL | 6.74 | 6.80 |
| High Protein - 30 mg β-glucan/250 mL | 6.77 | 6.85 |
| High Protein - 50 mg β-glucan/250 mL | 6.80 | 6.87 |

pH* - samples were brought to ambient temperature. pH was measured using a VWR pH Meter, Model 8000 with Orion Combination Electrode, calibrated with pH 4 and pH 7 buffers.

TABLE 4
TRIAL 2 - Viscosity Results of Pasteurized Drinks

| | Viscosity* | Shear Rate |
|---|---|---|
| Sample | (cps) | (second −1) |
| Vanilla Shake - Control | | |
| Speed 1 | 187.25 | 7.68 |
| Speed 2 | 45.11 | 33.0 |
| Speed 3 | 31.48 | 81.6 |
| Vanilla Shake - 10 mg β-glucan/250 mL, UHT | | |
| Speed 1 | 196.38 | 7.68 |
| Speed 2 | 49.40 | 33.0 |
| Speed 3 | 31.48 | 81.6 |
| Vanilla Shake - 30 mg β-glucan/250 mL, UHT | | |
| Speed 1 | 205.52 | 7.68 |
| Speed 2 | 51.55 | 33.0 |
| Speed 3 | 33.63 | 81.6 |
| Vanilla Shake - 50 mg β-glucan/250 mL, UHT | | |
| Speed 1 | 237.48 | 7.68 |
| Speed 2 | 58.00 | 33.0 |
| Speed 3 | 37.51 | 81.6 |
| Chocolate Lactose-Free Shake - Control | | |
| Speed 1 | 187.25 | 7.68 |
| Speed 2 | 48.33 | 33.0 |
| Speed 3 | 28.89 | 81.6 |

*Viscosity - determined using a Ferranti Portable Viscometer.

TABLE 5
Viscosity of Pasteurized Drinks

| | Viscosity* - after | |
|---|---|---|
| Sample | pasteurization | ShearRate |
| Chocolate L-F Shake - 10 mg | | |
| β-glucan/250 mL, UHT | | |
| Speed 1 | 191.81 | 7.68 |
| Speed 2 | 48.33 | 33.0 |
| Speed 3 | 31.91 | 81.6 |
| Chocolate L-F Shake - 30 mg | | |
| β-glucan/250 mL, UHT | | |
| Speed 1 | 214.65 | 7.68 |
| Speed 2 | 55.85 | 33.0 |
| Speed 3 | 34.50 | 81.6 |
| Chocolate L-F Shake - 50 mg | | |
| β-glucan/250 mL, UHT | | |
| Speed 1 | 0.177 | 15.6 |
| Speed 2 | 0.226 | 64.8 |
| Speed 3 | 0.192 | 160.8 |
| High Protein - Control | | |
| Speed 1 | 191.81 | 7.68 |
| Speed 2 | 49.40 | 33.0 |
| Speed 3 | 40.10 | 81.6 |
| High Protein - 10 mg | | |
| β-glucan/250 mL, UHT | | |
| Speed 1 | 196.38 | 7.68 |
| Speed 2 | 53.70 | 33.0 |
| Speed 3 | 41.40 | 81.6 |
| High Protein - 30 mg | | |
| β-glucan/250 mL, UHT | | |
| Speed 1 | 0.266 | 15.6 |
| Speed 2 | 0.226 | 64.8 |
| Speed 3 | 0.209 | 160.8 |
| High Protein - 50 mg | | |
| β-glucan/250 mL, UHT | | |
| Speed 1 | 0.266 | 15.6 |
| Speed 2 | 0.268 | 64.8 |
| Speed 3 | 0.259 | 160.8 |

### Example 2

### Sonication of Dairy Beverages Containing Beta-Glucan

About 10 mg of β-glucan was accurately weighed into a series of 50 mL centrifuge tubes (Polycarbonate, Nalgene, Rochester, N.Y.), and 25 mL of skim milk was added to the tubes. The mixtures were subsequently vortexed to bring the β-glucan into a suspension. The mixtures were sonicated for different length of time ranging from 0, through 3 min. using a High Intensity Ultrasonic Processor (Cole Parmer Instruments, Vernon Hills, Ill., Model 130W, 20 Hz, with microtip N6 mm). Mixtures that have skim milk with no β-glucan, β-glucan with no milk (water instead) were also included as controls that were treated without or with sonication.

The sonicated and control mixture were subsequently centrifuged (Sorvall Lengend RT, Mandel Scientific Company, Guelph, ON) at 500 g at 10° C. for 10 min to separate any suspended β-glucan from the milk. The centrifuge tubes were decanted to remove the supernatant milk, and subsequently added to the tubes with 25 mL of distilled water. The tubes were vortexed for 10 sec to re-suspend the precipitate into the water, and centrifuged again under the same conditions described above. This decanting, suspension and centrifugation steps were repeated another two times to remove any solubles from the precipitate. The final precipitates were suspended into 10 mL of distilled water each to form the sample suspensions that were kept for further analysis for β-glucan, as described below.

An aliquot of the above mentioned suspensions were pipetted into borosilic glass test tubes (N15×150 mm), and the amount of β-glucan in the aliquots was analyzed using the method described by Dubois et al (1960). A series of aliquots from a known amount of β-glucan stock suspension were used to construct a standard curve. The amount of β-glucan in the suspensions from the sonicated β-glucan containing milk was quantified accordingly.

The results indicated that sonication had major effect on stabilizing β-glucan in the skim milk test model. When the mixture of skim milk containing 10 mg of β-glucan was sonicated for 1 min under the conditions used, we found that the amount of β-glucan that can be separated by centrifugation was less than half of that which did not receive sonication (vortexed only instead). This is a drastic improvement in the stability of the suspension, even without any other stabilizing aids such as gum or emulsifiers. The result showed great promise in the use of sonication for the stabilization of suspensions, such as the β-glucan in milk system. Further studies are required to include different type of systems for the effect of stabilization.

TABLE 6
Results on the effects of sonication treatment of milk and β-glucan
mixture on the stability of β-glucan in skim milk suspension

| tube # | 1 | 2 | 3 | 4 | 5 | 6 |
|---|---|---|---|---|---|---|
| Sonication time, min | 0 | 0 | 1 | 2 | 3 | 3 |
| milk, mL | 25 | 25 | 25 | 25 | 25 | 25 |
| β-glucan added, mg, rep1 | 0 | 10.2 | 9.9 | 10.2 | 9.7 | 0 |
| Energy input, J | 0 | 0 | 1,000 | 2,000 | 2,991 | 3,100 |
| β-glucan added, mg, rep2 | 0 | 10.0 | 9.9 | 10.8 | 10.3 | 0 |
| Energy input, J | 0 | 0 | 1,040 | 2,080 | 3,161 | 3,099 |
| β-glucan recovered by centrifugation*, | | 100.0 | 31.2 | 49.0 | 40.9 | 5.0 |
| average of at least four analyses | | | | | | |
| standard deviation | | | 16.9 | 18.8 | 1.0 | 2.7 |

*The mixture of milk and β-glucan following sonication treatment was centrifuged under 500 g to precipitate any unstable β-glucan from the suspension that is used as a measurement for the stability of the suspension.

The results also showed that >1 min treatment did not improve the stability of the suspension further. This suggests that the maximum effects were achieved in a very short period of time in the milk system tested, indicating that benefits of sonication may be achieved. If this is confirmed to be the case, it would be more economically beneficial for large scale commercial use.

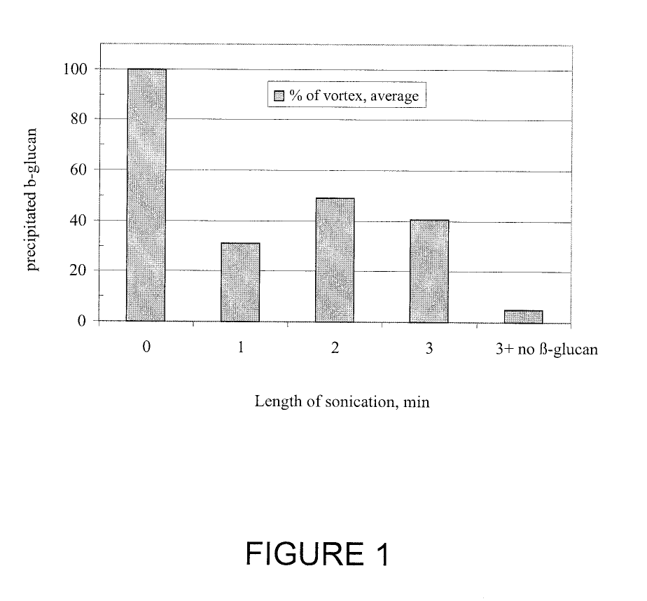

FIG. 1 illustrates the effect of sonication treatment on the stability of a suspension of yeast cell wall beta-glucan in skim milk, where a vortex was used in place of sonication as the control.

### Example 3

### Sonication of Dairy Beverages Containing Fruit Extracts

Skim milk (5 mL) aliquots were first introduced into glass test tubes (N15×150 mm) and fruit extracts were introduced in 0, 50:L intervals. The mixtures were vortexed at high speed intermittently for 5 seconds to dissipate the coagulates and bring the mixture to homogeneity. The mixtures in the tubes were sonicated for one minute using a High Intensity Ultrasonic Processor (microtip N3 mm).

The sonicated mixtures along with controls (no sonication) were transferred to a hot water (95° C.) bath and incubated for 10 min. The stability of the mixture was examined and recorded to assess the effect of ultrasound treatment on the stability of the mixtures containing fruit extracts.

Sonication treatment for 1 min on the mixtures of skim milk with cranberry extract improved the stability of the mixture system (Table 7). The mixtures were stable in a 95° C. water batch after 10 min of incubation. For comparison, the mixture started to gel without the treatment of sonication at the level of 2% cranberry extract. The result of gelling is an indication that the mixture has changed its physical properties (such as viscosity) and became a problem for proper sterilization of the mixture.

When the cranberry extract level reached 4% in the mixture, the mixtures started to form precipitate on heating in the water batch in the mixtures sonicated or not. This type of precipitation must be avoided in the sterilization of the beverages so that the product would be stable and the sterilization equipment would not be saved from fouling.

TABLE 7
Effect of sonication on the stability* of mixture
of skim milk containing cranberry extract

| Tube # | 1 | 2 | 3 | 4 | 5 | 6 | note |
|---|---|---|---|---|---|---|---|
| Extract, uL | 0 | 50 | 100 | 150 | 200 | 250 | |
| milk, mL | 5 | 5 | 5 | 5 | 5 | 5 | |
| sonication, J | 370 | 390 | 480 | 440 | 420 | 380 | sonicated |
| stability | stable | stable | stable | stable | precipitate | precipitate | |
| Tube # | 11 | 12 | 13 | 14 | 15 | 16 | note |
| Extract, uL | 0 | 50 | 100 | 150 | 200 | 250 | |
| milk, mL | 5 | 5 | 5 | 5 | 5 | 5 | |
| sonication, J | 0 | 0 | 0 | 0 | 0 | 0 | |
| sonication, J | stable | stable | gelled | gelled | precipitate | precipitate | control/no |
| | | | | | | | sonication |

*Stability was observed upon incubation of the mixtures incubated at 95° C. for 10 min.

The result in Table 8 indicated the effects of sonication on the stability of milk with different levels of blueberry extracts. Generally, the milk tolerated a higher level of addition (5% without sonication) in the blueberry extract as compared to the cranberry extract (2% without sonication). With sonication, the sonicated mixture seemed to perform differently from the one without sonication. The sonicated mixture showed only a slight separation at the top of the mixture as compared to a major separation of the mixture for the mixture without sonication at the 6% addition level. The results suggested different sensitivities of the suspension systems (milk with cranberry vs. with blueberry) to the treatment of sonication. In addition, sonication seemed to result in a higher stability for the mixture of skim milk with blueberry.

TABLE 9
Effect of sonication on the stability* of mixture
of skim milk containing blueberry extract

| Tube # | 1 | 2 | 3 | 4 | 5 | 6 | 7 | note |
|---|---|---|---|---|---|---|---|---|
| Extract, uL | 0 | 50 | 100 | 150 | 200 | 250 | 300 | |
| milk, mL | 5 | 5 | 5 | 5 | 5 | 5 | 5 | |
| sonication, J | 370 | 418 | 440 | 441 | 420 | 440 | 480 | sonicated |
| stability | stable | stable | stable | stable | stable | stable | slight separation | |
| Tube # | 11 | 12 | 13 | 14 | 15 | 16 | 17 | note |
| Extract, uL | 0 | 50 | 100 | 150 | 200 | 250 | 300 | |
| milk, mL | 5 | 5 | 5 | 5 | 5 | 5 | 5 | |
| sonication, J | 0 | 0 | 0 | 0 | 0 | 0 | 0 | control |

| | | | | | | | |
|---|---|---|---|---|---|---|---|
| stability | stable | stable | stable | stable | stable | stable | separated at top |

*Stability condition was observed upon incubation of the mixtures incubated at 95° C. for 10 min.

### Example 4

### Process for Stabilization of Dairy Beverages with Fruit Extracts by Homogenization

Homogenized milk aliquots (5 mL) were first introduced into glass test tubes (N15×150 mm) and fruit extracts were introduced at 0, 1, 2, 3, 4, 5, 6, 7 and 8% levels. This mixture series was prepared in several sets to receive different levels of homogenization effect. The mixtures were first vortexed at high speed intermittently for 5 seconds to dissipate the coagulates and bring the mixture to apparent homogeneity. The resulting mixtures in the tubes were homogenized using a hand-held homogenization device at high speed for 0, 1, 2, and 3 min for the different sets of the mixtures. All the mixtures were then put into a hot water batch (95° C.) for 10 min to induce any possible interaction that may happen at high temperatures. The incubated mixtures were cooled at room temperature and observed for stability.

Although the mixtures of homogenized milk and blueberry extract seemed all stable upon vortexing at room temperature, the mixtures with higher levels of blueberry extract produced precipitate upon heating in the water batch at 95° C. (Table 9). This would be highly problematic for the production of beverages that require heat treatment, particularly those that require high temperature treatment to achieve long term shelf life.

It was found that homogenization improves the stability of the mixtures. Under the laboratory conditions, homogenization improved the stability of the mixtures from 4% addition level for the extract to 6%. This needs to be confirmed at large scale where the treatment conditions simulate better the conditions of manufacture. The current results showed the promise of improvement in stability by using homogenization. It should be noted that the commercial homogenizers are better in effect in homogenization as they work under higher pressure and more vigorous conditions.

TABLE 9
Stability Observations

| Extract level, % | 0 | 1 | 2 | 3 | 4 | 5 | 6 | 7 | 8 |
|---|---|---|---|---|---|---|---|---|---|
| Homogenization | stable | stable | stable | stable | stable | gel | pasty | pasty | pasty |
| 0 min | | | | | | | | | |
| Homogenization | stable | stable | stable | stable | stable | stable | gel | ppt | ppt |
| 1 min | | | | | | | | | |
| Homogenization | stable | stable | stable | stable | stable | stable | stable | ppt | ppt |
| 2 min | | | | | | | | | |
| Homogenization | stable | stable | stable | stable | stable | stable | stable | ppt | ppt |
| 3 min | | | | | | | | | |

### Example 5

### High Temperature Sterilization of Beverages

20 kg of skim milk (Parmalat, 0.1% mf skim milk), obtained locally in Saint Hyacinthe, QC, was added to different types of fruit or yeast extracts at the desired levels. The mixture was stirred in milk cans (35 kg capacity) for 2 min using a Robot Coupe (Model MP 550 Turbo) to disperse the extracts. The mixtures as the beverages were temporarily stored at 4° C. for further processing.

Homogenization. The beverage mixture was homogenized in a Rannie homogenizer (Rannie Homogenisator, Bectrol Inc., Everett, Mass.) by passing through in a two stage process at 3,000 and 500 psi respectively.

UHT sterilization. The homogenized beverage mixture with the functional ingredients was sterilized in an Alfa-Laval SteriLab unit (Model TTO4 UHT steriliser Indirect). In the unit, the mixture was preheated to 75-80° C., and homogenized at this temperature by passing through 2,000 and 500 psi two pressure stages. The beverage mixture was subsequently sterilized under ultra high temperature conditions (140° C.×6 sec). The sterilized beverages were pre-cooled to about 60° C. and then further cooled to 4° C. The cooled product was bottled (250 mL, autoclaved) in an Alfa-Laval SteriCab (TT-02) aseptic cabinet under sterile conditions.

The sterilized beverages were monitored for shelf life in terms of physical stability, changes in functional ingredients, color and sensory properties.

Results on UHT Products Containing Fruit and β-glucan Extracts

The pilot scale experiment for the manufacture of shelf stable product containing the extract may be generally summarized in the following flowchart (Scheme 1):

The products from this process were monitored for shelf life. The results indicated excellent stability of the products after one full year. These values indicate that the products are within the normal and safe range of the pH values required to maintain the stability of the products. Any deviation from the normal values would suggest possible contamination of microorganisms or inefficient sterilization of the products, possibly caused by the included functional ingredients.

TABLE 10
The pH values (21° C.) of the UHT products.

| | pH | pH | pH |
|---|---|---|---|
| Samples | value | value | value |
| Skim milk with β-glucan (50 ppm) | 6.76 | 6.71 | 6.77 |
| Skim milk with blueberry extract (3.0%) | 6.54 | 6.50 | 6.57 |
| Skim milk with pomegranate concentrate (1.0%) | 6.58 | 6.57 | 6.63 |
| Skim milk with cranberry extract (1.0%) | 6.32 | 6.34 | 6.35 |
| Skim milk with cranberry extract (1.0%) and β- | 6.39 | 6.43 | 6.36 |
| glucan (50 ppm) | | | |

### Example 6

### High Temperature Sterilization of Milk Based Beverages

5,000 g of water was heated to 71° C. in a 10 L stainless steel pail; 80 g of pectin and 860 g of sugar were added to the water. The mixture was mixed to homogeneity and let cool. In a different stainless steel pail, 5 L of milk (2% milk fat), was added to 500 g skim milk powder, and the mixture was mixed well; fruit juice concentrate (145 g) was added and stirred. The two mixtures were then pooled and mixed to homogeneity. The mixture is here after termed as the dairy base.

To the dairy base was added the other functional foods or extracts. Alternatively, the fruit juice concentrates may be mixed into the milk mixture. The resulting mixture was mixed to homogeneity. The pH of the mixture was adjusted using lactic acid and/or potassium hydroxide (KOH) to desired value, in this case at pH 4.2. At this point, any flavour ingredients may be added and the final mixture, termed as the raw beverage, is mixed well and left at 4° C. The raw beverage is heated to 75° C., homogenized in a two stage homogenizer at 1500 psi and 500 psi, and then processed at 140° C. for 6.6 seconds. The processed beverage is immediately cooled to 15° C. and filled into 250 mL containers, sterile for evaluation and consumption.

### Example 7

### Beverage Containing Pectin and Yogurt

2,500 g of water was heated to 75° C. in a 10 L stainless steel pail. 80 g of pectin and 860 g of sugar were mixed into the water. While stirrer is mixing, 7,000 g of yogurt (Phoenicia, plain. Saint-Laurent, QC) was added. 25 g of peach flavour (Ottens, #20682) was stirred in and 145 g of peach juice concentrate was added. While the mixture is being stirred, the acidity of the mixture was adjusted to pH 4.36 with the use of KOH (39%, w/w) to produce the raw beverage.

The raw beverage was heated to 75° C., homogenized at 1,500 psi followed by 500 psi prior to UHT. The homogenized beverage was heated to 140° C. for six seconds and then immediately cooled down to 15° C. The processed beverage was filled into 250 mL containers for evaluation of quality and shelf-life or marketing for consumption.

### Examples 8

### Process for Preparation of Milk Based Beverage

160 g of pectin and 920 g of sugar were weighed and mixed. The mixture was subsequently added to 8L of water that was preheated to 70° C. under constant stirring. The mixture was stirred vigorously to form a solution, which was divided into two equal portions, termed as A and B for convenience. Both portions were left to cool until further use.

While 10L of 2% skim milk was being stirred, a mixture of 800 g of sugar and 1000 g of skim milk was poured into the milk, and dispersed into the milk. The resulting mixture is subsequently divided into two equal portions, termed as C and D, which were to be used for preparation of beverages in the following steps.

Preparation of a beverage that contains the nutrients of one serving of dairy and one serving of peach juice in one serving volume of the beverage is described below.

580 g of a commercially available peach juice concentrate was weighed out and added to the portion C under stirring, and further to the mixture was added portion A under stirring to form a uniform mixture. The mixture had a pH value of 6.04. To the mixture under stirring was slowly added 82 g of lactic acid (88%) to result in a composition that has a pH of 4.17, which was within the target of 4.1-4.2 for this batch of the preparation. Finally, 30 g of yogurt flavor and 30 g of peach flavor were added to the mixture which was stirred to uniformity to result in a raw beverage. This beverage, in one serving of 250 mL, contains the nutrients of one serving of dairy and one serving of peach juice.

In the above preparation, concentrated juice and skim milk powder were used to achieve the double serving nutrients in one serving volume of 250 mL. Similarly, evaporated milk may also be used. Alternatively, different combinations of the ingredients may be used to result in the same results.

Additionally, the above mixture would not be stable at room temperature, and will not be stable for more than two weeks even at refrigerated temperature. However, pasteurization or sterilization under normal processing conditions aimed at destroying the spoilage microbes would normally cause immediate chemical reactions and result in separation of distinct layers in the beverage.

The raw beverage mixture was therefore treated to stabilize the composition by using ultrasound or homogenization. In this case, the raw beverage was heated to 75° C., and immediately homogenized or ultrasound treated to achieve stabilization. The resulting composition was subsequently heated to 110° C. for 6 seconds, and cooled to room temperature. The cooled product is now a stabilized beverage that is commercially sterile and stable at room temperature for 12 months.

The stabilize beverage was filled into 250 mL bottles that have been previously cleaned and treated to be sterile. Each bottle of this beverage contains the nutrients of one serving of dairy and one serving of peach juice in one serving volume (250 mL) of the beverage.

Preparation of a beverage that contains the nutrients of one serving of dairy and one serving of strawberry and banana mixed fruits in one serving volume of the beverage is described below.

Under stirring, 500 g of banana puree was added to the above prepared portion D, and subsequently 481 g of strawberry juice concentrate was added to the mixture. The mixture was stirred to achieve uniformity and then the portion B was added to the mixture while the stirring is kept on to achieve a viscous but uniform mixture. Additionally, 52.3 g of lactic acid (88%) was slowly added and stirred into the mixture and then 30 g of yogurt flavor and 30 g of strawberry flavor were stirred in to achieve a composition that is the raw beverage. This beverage, in one serving of 250 mL, contains the nutrients of one serving of dairy and one serving of strawberry and banana fruits.

The raw beverage was heated to 75° C., and immediately homogenized or ultrasound treated to achieve stabilization. The resulting composition was subsequently heated to 110° C. for 6 seconds, and then cooled to room temperature. The product is now a stabilized beverage that is commercially sterile and stable at room temperature for 12 months.

The stabilize beverage was filled into 250 mL bottles that have been previously cleaned and treated to be sterile. Each bottle of this beverage contains the nutrients of one serving of dairy and one serving of strawberry and banana mixed fruits in one serving volume (250 mL) of the beverage.

### Example 9

### Beverage Composition with Fruit Juice

160 g of pectin and 1720 g of granular sugar were added to 5000 g of hot water that was preheated to 72° C. while the mixture was being stirred vigorously to achieve uniformity. The mixture is then divided into two equal portions termed A and B, which are put aside until further use.

Preparation of a beverage that contains the nutrients of one serving of dairy and one serving of blueberry juice in one serving volume of the beverage is described below.

500 g of skim milk was added to 5L of skim milk (2% milk fat) while the mixture being stirred. 607.9 g of blueberry juice concentrate was added to the milk mixture. After being stirred to uniformity, the above mentioned portion A was added to the milk under vigorous mixing to obtain a uniform mixture. When this is achieved, 48.8 g of lactic acid (88%) was added to the mixture to have the resulting mixture to have a pH value of 4.19. An additional 1.5 L of water was added to the mixture under stirring. Finally, 30 g of yogurt flavor and 30 g of blueberry flavor was added and stirred to uniformity. This is the raw beverage that, in one serving of 250 mL, contains the nutrients of one serving of dairy and one serving of blueberry juice.

The raw beverage was heated to 75° C., and immediately homogenized or ultrasound treated to achieve stabilization. The resulting composition was subsequently heated to 110° C. for 6 seconds, and then cooled to room temperature. The product is now a stabilized beverage that is commercially sterile and stable at room temperature for 12 months.

The stabilize beverage was filled into 250 mL bottles that have been previously cleaned and treated to be sterile. Each bottle of this beverage contains the nutrients of one serving of dairy and one serving of blueberry juice in one serving volume (250 mL) of the beverage.

Preparation of a beverage that contains the nutrients of one serving of dairy, as yogurt, and one serving of peach juice in one serving volume of the beverage is described below.

7 L of yogurt (1% milk fat) was added to a 10 L stainless steel pail and an overhead mixer is set up to stir the yogurt constantly. To the yogurt, 40 g of butterfat milk was added and stirred in, and subsequently 581 g of peach juice concentrate was added and also stirred into the mixture. While the yogurt mixture is being stirred by the mixer, the previously prepared portion B in this example was added, and the resulting mixture is further mixed to uniformity. The pH of the resulting mixture was found to be 4.22 and 4.4 g of lactic acid (88%) was added to adjust the pH of the mixture to 4.16. Finally, 30 g of peach flavor was added to the mixture which was subsequently stirred to form a uniform composition. This is the raw yogurt beverage.

The raw beverage would not be stable at room temperature, and will not be stable for more than two weeks even at refrigerated temperature as milk solids and fruits would separate to form distinctive layers.

The raw beverage can therefore be treated to stabilize the composition by using ultrasound or homogenization. In this case, the raw beverage was homogenized or ultrasound treated to achieve stabilization. The homogenization could be performed in different ways but in this case it was performed by using a two stage process with the first stage pressure set at 2500-2800 psi and 500 psi in the second stage. It was found that the beverage will not physically separate into layers of their respective components prior to spoilage due to microbial activity.

The raw beverage at this point still contains various microbes that would eventually cause spoilage of the beverage, either at room or at refrigerated temperature. Pasteurization or sterilization would destroy the microbes, which would prevent the beverage from spoilage but under normal processing conditions the process would have caused immediate separation of the beverage into different layers if without the stabilization step as described above. With the stabilization step already performed, the raw beverage composition was subsequently heated to 110° C. for 6 seconds, and cooled to room temperature. The cooled product is now a stabilized beverage that is commercially sterile and stable at room temperature for 12 months.

The stabilize beverage was filled into 250 mL bottles that have been previously cleaned and treated to be sterile. Each bottle of this beverage contains the nutrients of one serving of dairy and one serving of peach juice in one serving volume (250 mL) of the beverage.

### Examples 10

### Process for Preparation of Milk Based Beverage

160 g of pectin and 800 g of sugar were weighed and mixed. The mixture was subsequently added to 8L of water that was preheated to 65° C. under constant stirring. The mixture was stirred vigorously to form a solution, which was divided into two equal portions, termed as Portions 1 and 2 for convenience. Both portions were left to cool until further use.

While 10L of 2% skim milk was being stirred, a mixture of 720 g of sugar and 1000 g of buttermilk powder was poured into the milk, and dispersed into the milk. The resulting mixture is subsequently divided into two equal portions, termed as Portions 3 and 4, which were to be used for preparation of beverages in the following steps.

Preparation of a beverage that contains the nutrients of one serving of dairy and one serving of peach juice in one serving volume of the beverage is described below.

580 g of a commercially available peach juice concentrate was weighed out and added to the Portion 3 under stirring, and further to the mixture was added Portion 1 under stirring to form a uniform mixture. The mixture had a pH value of 5.79. To the mixture under stirring was slowly added 92 g of lactic acid (88%) to result in a composition that has a pH of 4.17, which was within the target of 4.1-4.2 for this batch of the preparation. 3 g of single strength cheese color is optionally added. Finally, 30 g of yogurt flavor and 40 g of peach flavor were added to the mixture. Additionally, a mixture of 100 g of granular sugar and 100 g of yogurt flavor powder was added to the mixture. This mixture was vigorously mixed or homogenized to result in a stabilized raw beverage. This beverage, in one serving of 250 mL, contains the nutrients of one serving of dairy and one serving of peach juice.

In the above preparation, concentrated juice and buttermilk powder were used to achieve the double serving nutrients in one serving volume of 250 mL. Similarly, evaporated milk may also be used. Alternatively, different combinations of the ingredients may be used to result in the same results.

Additionally, the above mixture would not be stable at room temperature, and will not be stable for more than two weeks even at refrigerated temperature. However, pasteurization or sterilization under normal processing conditions aimed at destroying the spoilage microbes would normally cause immediate chemical reactions and result in separation of distinct layers in the beverage.

The raw beverage mixture was therefore further treated to stabilize the composition by using ultrasound or homogenization. In this case, the raw beverage was heated to 120° C. for 6 seconds, then cooled to 75° C., and immediately homogenized or ultrasound treated to achieve long term stabilization. The resulting composition was subsequently and cooled to room temperature. This resulting product is commercially sterile and stable at room temperature for 12 months.

The stabilize beverage was filled into 250 mL bottles that have been previously cleaned and treated to be sterile. Each bottle of this beverage contains the nutrients of one serving of dairy and one serving of peach juice in one serving volume (250 mL) of the beverage.

### Example 11

### Beverage Composition with Fruit Juice

Preparation of a beverage that contains the nutrients of one serving of dairy and one serving of blueberry juice in one serving volume of the beverage is described below.

500 g of buttermilk powder was added to 5 L of skim milk (2% milk fat) while the mixture being stirred. 607.9 g of blueberry juice concentrate was added to the milk mixture. After being stirred to uniformity, the above mentioned Portion 2 was added to the milk under vigorous mixing to obtain a uniform mixture. When this is achieved, 51 g of lactic acid (88%) was added to the mixture to have the resulting mixture to have a pH value of 4.19. Finally, 30 g of yogurt flavor and 40 g of blueberry flavor was added and stirred to uniformity. Subsequently, a mixture of 100 g of granular sugar and 100 g of yogurt flavor powder was added to the mixture. Optionally, 1 g of vanilla flavor was added to the mixture. This mixture was vigorously mixed or homogenized to result in a stabilized raw beverage. This beverage, in one serving of 250 mL, contains the nutrients of one serving of dairy and one serving of peach juice.

The raw beverage at this point still contains various microbes that would eventually cause spoilage of the beverage, either at room or at refrigerated temperature. Pasteurization or sterilization would destroy the microbes, which would prevent the beverage from spoilage but under normal processing conditions the process would have caused immediate separation of the beverage into different layers if without the stabilization step as described above. With the stabilization step already performed, the raw beverage was heated to 120° C. for 6 seconds, and then cooled down to 75° C., and was immediately homogenized or ultrasound treated to further stabilize the product. The resulting composition was then cooled to room temperature. The product is now a stabilized beverage that is commercially sterile and stable at room temperature for 12 months. The homogenization process was a two stage process with the first stage pressure set at 2500-2800 psi and 500 psi in the second stage. It was found that the beverage will not physically separate into layers of their respective components prior to spoilage due to microbial activity.

The stabilize beverage was filled into 250 mL bottles that have been previously cleaned and treated to be sterile. Each bottle of this beverage contains the nutrients of one serving of dairy and one serving of blueberry juice in one serving volume (250 mL) of the beverage.

The above-described embodiments of the invention are intended to be examples only. Alterations, modifications and variations can be effected to the particular embodiments by those of skill in the art without departing from the scope of the invention, which is defined solely by the claims appended hereto.

### REFERENCES

Bell et al. 2001. U.S. Pat. No. 6,210,686. Dietary supplement and method for lowering risk of heart disease.

Donzis, B A. 1996. U.S. Pat. No. 5,576,015. Substantially purified beta (1,3) finely ground yeast cell wall glucan composition with dermalogical and nutritional uses.

Dubois, M., K. A. Gilles, J. K. Hamilton, P. A. Rebers, and F. Smith. 1956. Colorimetric method for determination of sugars and related substances. Analytical Chemistry. 28:350-356.

Greenshields R. 1999. U.S. Pat. No. 5,968,811. Processing of yeast refuse and resulting product.

Hayden G D et al. 2001. U.S. Pat. No. 6,214,337. Animal feeds comprising yeast glucan.

Miura, N. N. et al. 2003. Structure and biological activities of β-glucans form yeast and mycelial forms of Candida albicans. Microbiology and Immunology. 47:Pp173-182.

Novak, M., and Vetvicka, V. 2008. ∃-glucans, history, and the present: Immunomodulatory aspects and mechanisms of action. J. Immunotoxicol. 5:47-57.

Neugebauer, O. 2007. EP 1 908 358. Health food Composition.

Ohno, N. 2005. Structural diversity and physiological functions of β-glucans. Intl. J. Medicinal Mushrooms. 7:167-173

Perez-Guisado, J. 2007. Arguments in favour of incorporating beta-D-glucans in food. Endocrinologia y Nutrition. 54:315-324.

Sandula, J. 1995. Structural characteristics and immunomodulatory activity of β-glucans isolated form Saccharomyces cerevisiae and Aspergillus niger. Acta Microbiologica et Immunologica Hungarica. 43: 231.

Spiros et al. 1990. U.S. Pat. No. 4,962,094. Glucan dietary additives.

Vetvicka, V., and Vetvickova, J. 2007. Physiological effects of different types of β-glucan. Biomed Pap Med Fac Univ Palacky Olomouc Czech Repub. 151/2, 225.

Yadomae, T. 1992. Immunopharmacological activities of β-glucans: Structural-activity relationships in relation to various conformations. Jpn. J. Medical Mycology. 33:267-277.

Zekovic, D. B. et al. 2005. Natural and modified (1,sH3)-β-glucans in health promotion and disease alleviation. Critical Reviews in Biotechnology. 25: 205-230.

1. A process for preparing a stable functional beverage composition comprising:
obtaining a suitable protein-containing carrier;
adding a functional ingredient to the carrier to provide a beverage composition; and
subjecting the beverage composition to intense agitation during and/or after addition of the functional ingredient to thereby stabilize the beverage composition to form a stable functional beverage composition;
wherein the functional ingredient comprises beta-glucan at a concentration of about 10 mg/L to about 20,000 mg/L in the beverage composition.

2. The process of claim 1, wherein the intense agitation is homogenization or sonication.

3. The process of claim 1, further comprising heat-treatment to extend the shelf-life of the beverage composition.

4. The process of claim 3, wherein the heat-treatment is carried out after the intense agitation.

5. (canceled)

6. (canceled)

7. The process of claim 1, wherein the pH of the beverage composition is adjusted to a desired value for optimal shelf stability.

8. The process of claim 1, wherein the protein-containing carrier is milk and the functional ingredient comprises beta-glucan derived from a yeast cell wall.

9. A stable functional beverage composition comprising a functional ingredient and a suitable protein-containing carrier, wherein the composition is prepared by combining the functional ingredient with the protein-containing carrier under intense agitation to stabilize the beverage composition;
wherein the functional ingredient comprises beta-glucan at a concentration of about 10 mg/L to about 20,000 mg/L in the beverage composition.

10. The composition of claim 9, wherein the protein-containing carrier is a dairy product.

11. The composition of claim 10, additionally comprising a fruit extract having antioxidant and/or antimicrobial properties.

12. The composition of claim 9, wherein the beta-glucan is derived from yeast cell wall.

13. The composition of claim 12, wherein the yeast cell wall is from Saccharomyces cerevisiae.

14. (canceled)

15. (canceled)

16. The composition of any claim 9, which is heat-treated for extended shelf-life.

17. The composition of claim 16, which is shelf-stable.

18. The composition of claim 17, which is shelf-stable for at least 12 months.

19. The composition of claim 10, wherein the dairy product is milk or a derivative thereof.

20. The composition of claim 19, wherein the milk or derivative thereof is lactose-free.

21. A shelf-stable functional dairy beverage composition comprising yeast-derived beta-glucan at a concentration of about 10 mg/L to about 20,000 mg/L in the beverage composition.

22. (canceled)

23. The stable functional beverage composition of claim 9, wherein the protein-containing carrier is in a concentrated form, and the functional ingredient is in a concentrated form.

24. (canceled)

25. (canceled)

26. (canceled)

27. The composition of claim 9, comprising from 10 to 100 mg of beta-glucan per 250 mL serving.

28. The process of claim 1, wherein the beverage composition comprises from 10 to 100 mg of beta-glucan per 250 mL serving.
